(19) United States
(12) Patent Application Publication
(10) Pub. No.: US 2024/0109433 A1
(43) Pub. Date: Apr. 4, 2024

(54) VEHICLE

(71) Applicant: SUBARU CORPORATION, Tokyo (JP)

(72) Inventors: Yasushi TAKAGI, Tokyo (JP); Hayata MIMATSU, Tokyo (JP)

(21) Appl. No.: 18/468,013

(22) Filed: Sep. 15, 2023

(30) Foreign Application Priority Data
Sep. 28, 2022 (JP) 2022-154927

(51) Int. Cl. B60L 50/16; B60L 3/00; B60L 50/61

(52) U.S. Cl. CPC B60L 50/16; B60L 3/0046; B60L 50/61; B60L 2210/10; B60L 2240/66

(57) ABSTRACT

A vehicle includes a high-voltage battery, a motor generator, a high-voltage system wire configured to electrically couple the high-voltage battery and the motor generator, a system main relay configured to turn ON or OFF electric coupling between the high-voltage battery and the motor generator on the high-voltage system wire, an atmospheric pressure sensor configured to detect an atmospheric pressure at a position of the vehicle, and a control device. The control device includes one or more processors, and one or more memories coupled to the one or more processors. The one or more processors are configured to execute a process including performing SMR-OFF control for controlling the system main relay to turn OFF when the system main relay is ON and the atmospheric pressure detected by the atmospheric pressure sensor is lower than a first atmospheric pressure threshold.

### CROSS-REFERENCE TO RELATED APPLICATIONS

The present application claims priority from Japanese Patent Application No. 2022-154927 filed on Sep. 28, 2022, the entire contents of which are hereby incorporated by reference.

### BACKGROUND

The disclosure relates to a vehicle.

For example, Japanese Unexamined Patent Application Publication (JP-A) No. 2021-46186 discloses traveling control on a hybrid electric vehicle including a high-voltage battery. In JP-A No. 2021-46186, when an overvoltage is generated in a battery pack, a system main relay is turned OFF and the state of the vehicle is set to a battery-less traveling state in which the vehicle can travel by using power of an engine.

### SUMMARY

An aspect of the disclosure provides a vehicle. The vehicle includes a high-voltage battery, a motor generator, a high-voltage system wire, a system main relay, an atmospheric pressure sensor, and a control device. The high-voltage system wire is configured to electrically couple the high-voltage battery and the motor generator. The system main relay is configured to turn ON or OFF electric coupling between the high-voltage battery and the motor generator on the high-voltage system wire. The atmospheric pressure sensor is configured to detect an atmospheric pressure at a position of the vehicle. The control device includes one or more processors and one or more memories coupled to the one or more processors. The one or more processors are configured to execute a process including performing SMR-OFF control for controlling the system main relay to turn OFF when the system main relay is ON and the atmospheric pressure detected by the atmospheric pressure sensor is lower than a first atmospheric pressure threshold.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating the configuration of a vehicle according to an embodiment;

FIG. 2 illustrates a relationship between an atmospheric pressure and a voltage;

FIG. 3 is a flowchart illustrating a flow of operation of a vehicle controller;

FIG. 4 is a flowchart illustrating a flow of SMR-OFF control;

FIG. 5 is a flowchart illustrating a flow of normal state restoration control; and

FIG. 6 is a flowchart illustrating a flow of SMR-ON control.

### DETAILED DESCRIPTION

For example, a vehicle may travel toward a high-altitude place. In the high-altitude place, the atmospheric pressure is lower than that in a low-altitude place. When the atmospheric pressure decreases at the position of the vehicle, electric discharge into the air may occur at, for example, an output terminal of a battery pack that houses a high-voltage battery. The electric discharge may damage, for example, the battery pack or devices around the output terminal.

It is desirable to provide a vehicle that can suppress electric discharge.

An embodiment of the disclosure is described in detail with reference to the accompanying drawings. Unless otherwise noted, the embodiment of the disclosure is not limited to specific dimensions, materials, and numerical values described herein because they are examples to facilitate understanding. In the description given herein and in the accompanying drawings, elements having substantially the same functions and configurations are represented by the same reference symbols to omit redundant description. Illustration is omitted for elements that are not related directly to the embodiment of the disclosure.

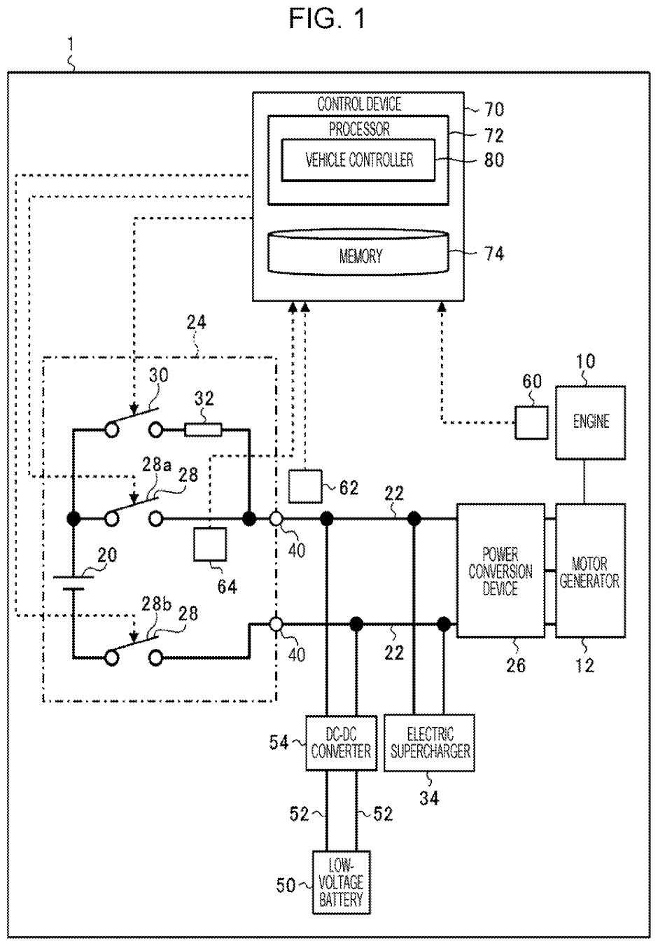

FIG. 1 is a schematic diagram illustrating the configuration of a vehicle 1 according to this embodiment. The vehicle 1 is a hybrid electric vehicle including an engine 10 and a motor generator 12 as drive sources for traveling. For convenience of the description, the motor generator 12 may be referred to as “MG”.

A crankshaft of the engine 10 and a rotation shaft of the motor generator 12 are coupled to each other and to wheels. The vehicle 1 can travel by using power of the engine 10 and cause the motor generator 12 to generate electric power in response to rotation of the engine 10. The vehicle 1 can travel by using power of the motor generator 12.

The vehicle 1 includes a high-voltage battery 20, high-voltage system wires 22, a battery pack 24, a power conversion device 26, a system main relay 28, a pre-charge relay 30, a pre-charge resistor 32, and an electric supercharger 34.

The high-voltage battery 20 is a chargeable and dischargeable secondary battery such as a lithium ion battery. For example, the voltage of the high-voltage battery 20 is a predetermined voltage of 100 V or higher, and is higher than the voltage of a low-voltage battery described later.

The high-voltage system wires 22 can electrically couple the high-voltage battery 20 and the motor generator 12.

The battery pack 24 is a hollow container. The high-voltage battery 20 is housed in the battery pack 24. The battery pack 24 has output terminals 40. The output terminals 40 of the battery pack 24 are electrically coupled to the high-voltage system wires 22. For example, the battery pack 24 is provided at the bottom of the vehicle 1. The output terminals 40 of the battery pack 24 are exposed to an environment having substantially the same atmospheric pressure as the atmospheric pressure outside the vehicle 1 at the position of the vehicle 1.

Examples of the power conversion device 26 include an inverter. The direct-current (DC) end of the power conversion device 26 is electrically coupled to the output terminals 40 of the battery pack 24 through the high-voltage system wires 22. The alternating-current (AC) end of the power conversion device 26 is electrically coupled to the motor generator 12. The power conversion device 26 can convert DC power at the DC end into AC power and supply the AC power to the motor generator 12 at the AC end. The power conversion device 26 can convert AC power generated by the motor generator 12 into DC power and supply the DC power to the DC end.

The system main relay 28 is housed in the battery pack 24. The system main relay 28 turns ON or OFF electric coupling between the high-voltage battery 20 and the motor generator 12 on the high-voltage system wires 22. For convenience of the description, the system main relay 28 may hereinafter be referred to as “SMR”. The system main relay 28 includes a cathode-side main relay 28a and an anode-side main relay 28b.

A first contact out of two contacts of the cathode-side main relay 28a is coupled to a cathode of the high-voltage battery 20. A second contact out of the two contacts of the cathode-side main relay 28a is coupled to a cathode output terminal 40 of the battery pack 24.

A first contact out of two contacts of the anode-side main relay 28b is coupled to an anode of the high-voltage battery 20. A second contact out of the two contacts of the anode-side main relay 28b is coupled to an anode output terminal 40 of the battery pack 24.

The pre-charge relay 30 and the pre-charge resistor 32 are housed in the battery pack 24. A first contact out of two contacts of the pre-charge relay 30 is coupled to the cathode of the high-voltage battery 20. A second contact out of the two contacts of the pre-charge relay 30 is coupled to a first end out of two ends of the pre-charge resistor 32. A second end out of the two ends of the pre-charge resistor 32 is coupled to the second contact of the cathode-side main relay 28a and the cathode output terminal 40 of the battery pack 24. That is, the pre-charge relay 30 and the pre-charge resistor 32 are coupled in series. The pre-charge relay 30 and the pre-charge resistor 32 coupled in series are coupled in parallel to the cathode-side main relay 28a.

The electric supercharger 34 is electrically coupled between the output terminals 40 of the battery pack 24 and the DC end of the power conversion device 26 on the high-voltage system wires 22. The electric supercharger 34 is provided in an intake passage of the engine 10. The electric supercharger 34 consumes electric power supplied through the high-voltage system wires 22 to compress air sent into the intake passage and supply the compressed air to the engine 10. Electric devices electrically coupled to the high-voltage system wires 22 are not limited to the electric supercharger 34. Any electric device that operates by a high voltage may electrically be coupled to the high-voltage system wires 22.

The vehicle 1 includes a low-voltage battery 50, low-voltage system wires 52, and a DC-DC converter 54. The low-voltage battery 50 is a chargeable and dischargeable secondary battery such as a lead-acid battery or a lithium ion battery. For example, the voltage of the low-voltage battery 50 is 12 V or 24 V, and is lower than the voltage of the high-voltage battery 20.

The low-voltage system wires 52 can electrically be coupled to the low-voltage battery 50. Any electric device that operates by a low voltage, such as an auxiliary device, may electrically be coupled to the low-voltage system wires 52.

An input end of the DC-DC converter 54 is electrically coupled between the system main relay 28 and the motor generator 12 on the high-voltage system wires 22. For example, the input end of the DC-DC converter 54 is electrically coupled between the output terminals 40 of the battery pack 24 and the DC end of the power conversion device 26 on the high-voltage system wires 22. An output end of the DC-DC converter 54 is electrically coupled to the low-voltage system wires 52.

The DC-DC converter 54 can convert electric power on the high-voltage system wires 22 and supply the electric power to the low-voltage system wires 52. When the DC-DC converter 54 is ON, the electric power on the high-voltage system wires 22 is supplied to the low-voltage system wires 52. The electric power supplied to the low-voltage system wires 52 through the DC-DC converter 54 is supplied to, for example, the low-voltage battery 50. When the DC-DC converter 54 is OFF, the power conversion is not performed by the DC-DC converter 54 and no electric power is supplied from the high-voltage system wires 22 to the low-voltage system wires 52.

The vehicle 1 includes an atmospheric pressure sensor 60, a voltage sensor 62, and a current sensor 64. The atmospheric pressure sensor 60 detects an atmospheric pressure at the position of the vehicle. For example, the atmospheric pressure sensor 60 is provided in an engine compartment. The inside of the engine compartment is exposed to an environment having the same atmospheric pressure as the atmospheric pressure outside the vehicle 1 at the position of the vehicle 1. Therefore, the atmospheric pressure sensor 60 detects the pressure of outside air at the position of the vehicle 1 instead of in a vehicle cabin, that is, a barometric pressure. For convenience of the description, the atmospheric pressure at the position of the vehicle may hereinafter be referred to as “atmospheric pressure of vehicle 1”. The voltage sensor 62 detects a voltage of the output terminals 40 of the battery pack 24. The current sensor 64 detects a current flowing through the system main relay 28.

The vehicle 1 includes a control device 70. The control device 70 includes one or more processors 72 and one or more memories 74 coupled to the processors 72. The memory 74 includes a ROM that stores programs and the like, and a RAM serving as a working area. The processor 72 of the control device 70 serves as a vehicle controller 80 in cooperation with the programs in the memory 74. The vehicle controller 80 controls the overall vehicle 1. For example, the vehicle controller 80 controls ON/OFF of the system main relay 28 and traveling conditions of the vehicle.

For example, the vehicle 1 may travel toward a high-altitude place. In the high-altitude place, the atmospheric pressure is lower than that in a low-altitude place. When the atmospheric pressure decreases at the position of the vehicle 1, electric discharge into the air may occur at, for example, the output terminals 40 of the battery pack 24 that houses the high-voltage battery 20. The electric discharge may damage, for example, the battery pack 24 or devices around the output terminals 40.

When the system main relay 28 is ON and the atmospheric pressure detected by the atmospheric pressure sensor 60 is lower than a first atmospheric pressure threshold, the vehicle controller 80 of the vehicle 1 of this embodiment performs SMR-OFF control for turning OFF the system main relay 28.

When the system main relay 28 is turned OFF, the high-voltage battery 20 is electrically isolated from the high-voltage system wires 22. Then, the voltage of the output terminals 40 of the battery pack 24 does not depend on the high voltage of the high-voltage battery 20. Thus, the electric discharge can be suppressed at the output terminals 40 of the battery pack 24. The control of the vehicle controller 80 is described in detail.

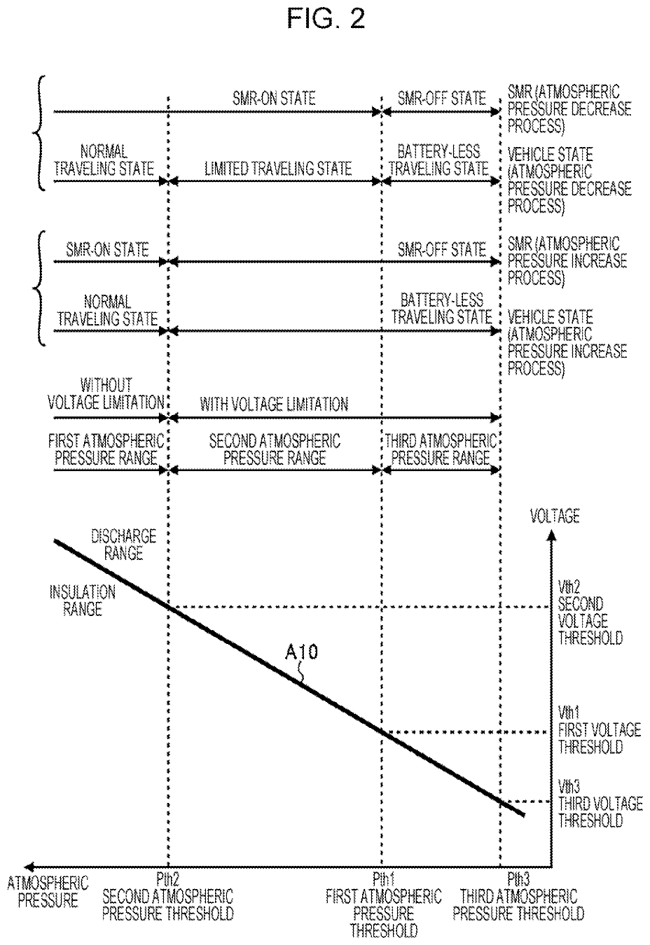

FIG. 2 illustrates a relationship between the atmospheric pressure and the voltage. In FIG. 2, the horizontal axis represents the atmospheric pressure detected by the atmospheric pressure sensor 60. In FIG. 2, the atmospheric pressure decreases toward the right side of the horizontal axis. For example, the atmospheric pressure detected by the atmospheric pressure sensor 60 decreases as the altitude at the position of the vehicle 1 increases. In FIG. 2, the vertical axis represents the voltage of the output terminals 40 of the battery pack 24 detected by the voltage sensor 62. In FIG. 2, the voltage decreases toward the lower side of the vertical axis.

In FIG. 2, the solid line A10 is a discharge border line indicting a border between an insulation range in which no electric discharge is assumed to occur at the output terminals 40 of the battery pack 24 and a discharge range in which electric discharge is assumed to occur at the output terminals 40 of the battery pack 24. In FIG. 2, the insulation range is a range of lower voltage across the discharge border line, and the discharge range is a range of higher voltage across the discharge border line. As illustrated in FIG. 2, the electric discharge is more likely to occur even at a low voltage as the atmospheric pressure decreases.

In the vehicle 1, three thresholds that are a first atmospheric pressure threshold Pth1, a second atmospheric pressure threshold Pth2, and a third atmospheric pressure threshold Pth3 are preset for the atmospheric pressure of the vehicle 1. The first atmospheric pressure threshold Pth1 is lower than the second atmospheric pressure threshold Pth2. In other words, the second atmospheric pressure threshold Pth2 is higher than the first atmospheric pressure threshold Pth1. The third atmospheric pressure threshold Pth3 is lower than the first atmospheric pressure threshold Pth1.

In a first atmospheric pressure range, the atmospheric pressure of the vehicle 1 is equal to or higher than the second atmospheric pressure threshold Pth2. In a second atmospheric pressure range, the atmospheric pressure of the vehicle 1 is lower than the second atmospheric pressure threshold Pth2 and equal to or higher than the first atmospheric pressure threshold Pth1. In a third atmospheric pressure range, the atmospheric pressure of the vehicle 1 is lower than the first atmospheric pressure threshold Pth1 and equal to or higher than the third atmospheric pressure threshold Pth3.

For example, the second atmospheric pressure threshold Pth2 is set to an atmospheric pressure corresponding to a standard barometric pressure at an altitude of 4300 m. For example, the third atmospheric pressure threshold Pth3 is set to an atmospheric pressure corresponding to a standard barometric pressure at an altitude of 6000 m. The first atmospheric pressure threshold Pth1 is set to an atmospheric pressure corresponding to a standard barometric pressure at a predetermined altitude from 4300 m to 6000 m. The predetermined altitude related to the first atmospheric pressure threshold Pth1 is determined in consideration of, for example, insulation resistances of various high-voltage components and the rated voltage of the high-voltage battery 20.

A first voltage threshold Vth1 is a voltage at an intersection of the first atmospheric pressure threshold Pth1 and the discharge border line. A second voltage threshold Vth2 is a voltage at an intersection of the second atmospheric pressure threshold Pth2 and the discharge border line. A third voltage threshold Vth3 is a voltage at an intersection of the third atmospheric pressure threshold Pth3 and the discharge border line. The first voltage threshold Vth1 is lower than the second voltage threshold Vth2. The third voltage threshold Vth3 is lower than the first voltage threshold Vth1.

For example, the second voltage threshold Vth2 is set substantially equal to an upper limit voltage of the high-voltage battery 20. The third voltage threshold Vth3 is a voltage close to a lower limit voltage of the high-voltage battery 20, and is set to a voltage higher than the lower limit voltage of the high-voltage battery 20 by a predetermined value. For example, the predetermined value is 20 V but may be set to any value.

For example, the upper limit voltage of the high-voltage battery 20 is assumed to be equal to the second voltage threshold Vth2. Then, the upper limit voltage of the output terminals 40 of the battery pack 24 is also the second voltage threshold Vth2. In this case, electric discharge is less likely to occur in the first atmospheric pressure range because the upper limit voltage of the output terminals 40 of the battery pack 24 is lower than the discharge border line. Therefore, the performance of the vehicle 1 is secured in the first atmospheric pressure range.

When the atmospheric pressure of the vehicle 1 is lower than the second atmospheric pressure threshold Pth2, the upper limit voltage of the output terminals 40 of the battery pack 24 is higher than the discharge border line and belongs to the discharge range. In this situation, electric discharge is likely to occur at the output terminals 40 of the battery pack 24 when the voltage of the output terminals 40 of the battery pack 24 is the upper limit voltage.

In the range in which the atmospheric pressure of the vehicle 1 is lower than the second atmospheric pressure threshold Pth2, that is, in the second atmospheric pressure range or the third atmospheric pressure range, the vehicle controller 80 limits the voltage of the output terminals 40 of the battery pack 24.

It is assumed that the atmospheric pressure of the vehicle 1 is in an atmospheric pressure decrease process or in an atmospheric pressure increase process. In the atmospheric pressure decrease process, the atmospheric pressure of the vehicle 1 changes from the first atmospheric pressure range to the second atmospheric pressure range and then from the second atmospheric pressure range to the third atmospheric pressure range. In the atmospheric pressure increase process, the atmospheric pressure of the vehicle 1 temporarily belongs to the third atmospheric pressure range and changes from the third atmospheric pressure range to the second atmospheric pressure range and then from the second atmospheric pressure range to the first atmospheric pressure range.

In the vehicle 1, the state of the vehicle, the state of the system main relay 28, and the state of the voltage limitation are different between the atmospheric pressure decrease process and the atmospheric pressure increase process.

A normal traveling state, a limited traveling state, and a battery-less traveling state are provided as the state of the vehicle. In the normal traveling state, the vehicle can travel by using the motor generator 12, and the voltage of the output terminals 40 of the battery pack 24 is not limited.

In the limited traveling state, the vehicle can travel by using the motor generator 12, but the voltage of the output terminals 40 of the battery pack 24 is limited. In the limited traveling state, predetermined functional limitation such as acceleration limitation may be made in the traveling using the motor generator 12.

In the battery-less traveling state, the vehicle cannot travel by using the motor generator 12 but can travel by using the engine 10, and the motor generator 12 can generate electric power. In the battery-less traveling state, the system main relay 28 is OFF and therefore the motor generator 12 is electrically isolated from the high-voltage battery 20 as described later. In the battery-less traveling state, electric power cannot be supplied from the high-voltage battery 20 to the motor generator 12, and the vehicle cannot travel by using the motor generator 12. In the battery-less traveling state, the vehicle can travel by using the engine 10 in place of the motor generator 12. Therefore, in the battery-less traveling state, the vehicle can travel by using the engine 10 without consuming electric power of the high-voltage battery 20. Thus, “battery-less” in the battery-less traveling state does not mean the low-voltage battery but means the high-voltage battery.

In the battery-less traveling state, electric power generated by the motor generator 12 may be supplied to the low-voltage battery 50 through the power conversion device 26, the high-voltage system wires 22, the DC-DC converter 54, and the low-voltage system wires 52. In the battery-less traveling state, the power of the engine 10 is limited. Therefore, the electric power generated by the motor generator 12 is limited. As a result, the voltage of the output terminals 40 of the battery pack 24 is limited.

The system main relay 28 is ON in the normal traveling state and the limited traveling state. The system main relay 28 is OFF in the battery-less traveling state.

In the first atmospheric pressure range, the state of the vehicle is the normal traveling state and the system main relay 28 is ON irrespective of the atmospheric pressure decrease process and the atmospheric pressure increase process.

When the atmospheric pressure of the vehicle 1 changes from the first atmospheric pressure range to the second atmospheric pressure range in the atmospheric pressure decrease process, the vehicle controller 80 switches the state of the vehicle from the normal traveling state to the limited traveling state. At this time, the system main relay 28 is kept ON.

In the limited traveling state, the vehicle controller 80 proportionally reduces the voltage of the output terminals 40 of the battery pack 24 substantially parallel to the discharge border line as the atmospheric pressure of the vehicle 1 decreases. For example, the vehicle controller 80 controls the power conversion device 26 to increase the output voltage at the AC end of the power conversion device 26 based on the amount of decrease in the atmospheric pressure of the vehicle 1. Then, electric power consumed by the motor generator 12 increases, and electric power transferred from the high-voltage battery 20 to the high-voltage system wires 22 increases to compensate for the increase in the power consumption of the motor generator 12. As a result, the voltage of the output terminals 40 of the battery pack 24 decreases depending on the amount of the electric power transferred from the high-voltage battery 20 to the high-voltage system wires 22.

When the atmospheric pressure of the vehicle 1 changes from the second atmospheric pressure range to the third atmospheric pressure range in the atmospheric pressure decrease process, the vehicle controller 80 switches the system main relay 28 from ON to OFF. The vehicle controller 80 switches the state of the vehicle from the limited traveling state to the battery-less traveling state.

In the battery-less traveling state, the vehicle controller 80 limits the voltage of the output terminals 40 of the battery pack 24 so that the voltage of the output terminals 40 is kept at a constant voltage equal to the third voltage threshold Vth3.

Since the system main relay 28 is OFF in the battery-less traveling state, the output terminals of the battery pack 24 are electrically isolated from the high-voltage battery 20.

In the battery-less traveling state, electric power generated by the motor generator 12 is supplied to the low-voltage system wires 52 through the DC-DC converter 54. Therefore, the voltage of the output terminals 40 of the battery pack 24 in the battery-less traveling state is a voltage substantially associated with a difference between the electric power generated by the motor generator 12 and the electric power at the output end of the DC-DC converter 54. The electric power generated by the motor generator 12 can be controlled based on the power of the engine 10. In the battery-less traveling state, the vehicle controller 80 performs control to reduce the power of the engine 10 so that the voltage of the output terminals 40 of the battery pack 24 is kept at a constant voltage equal to the third voltage threshold Vth3.

When the atmospheric pressure of the vehicle 1 is lower than the third atmospheric pressure threshold Pth3, the vehicle controller 80 may stop the traveling of the vehicle using the engine 10 in addition to the stop of the traveling of the vehicle using the motor generator 12. In this case, the motor generator 12 may be rotated by the engine 10 to keep power generation by the motor generator 12.

It is assumed that the atmospheric pressure of the vehicle 1 in the battery-less traveling state changes from the third atmospheric pressure range to the second atmospheric pressure range in the atmospheric pressure increase process. In the atmospheric pressure increase process, the system main relay 28 is kept OFF and the battery-less traveling state is kept in the second atmospheric pressure range similarly to the third atmospheric pressure range.

When the atmospheric pressure of the vehicle 1 in the battery-less traveling state changes from the second atmospheric pressure range to the first atmospheric pressure range in the atmospheric pressure increase process, the vehicle controller 80 switches the system main relay from OFF to ON. The vehicle controller 80 restores the state of the vehicle from the battery-less traveling state to the normal traveling state.

When the state of the vehicle is the battery-less traveling state and the atmospheric pressure detected by the atmospheric pressure sensor 60 is equal to or higher than the second atmospheric pressure threshold Pth2, the vehicle controller 80 performs normal state restoration control for restoring the state of the vehicle to the normal traveling state.

In FIG. 2, the description has been made about the change from the first atmospheric pressure range to the second atmospheric pressure range and then from the second atmospheric pressure range to the third atmospheric pressure range, and about the change from the third atmospheric pressure range to the second atmospheric pressure range and then from the second atmospheric pressure range to the first atmospheric pressure range. For example, the atmospheric pressure may change from the first atmospheric pressure range to the second atmospheric pressure range and then return from the second atmospheric pressure range to the first atmospheric pressure range without reaching the third atmospheric pressure range. In this case, the state of the vehicle changes from the normal traveling state to the limited traveling state and then from the limited traveling state to the normal traveling state. For example, the atmospheric pressure may change from the third atmospheric pressure range to the second atmospheric pressure range and then return from the second atmospheric pressure range to the third atmospheric pressure range without reaching the first atmospheric pressure range. In this case, the vehicle is kept in the battery-less traveling state.

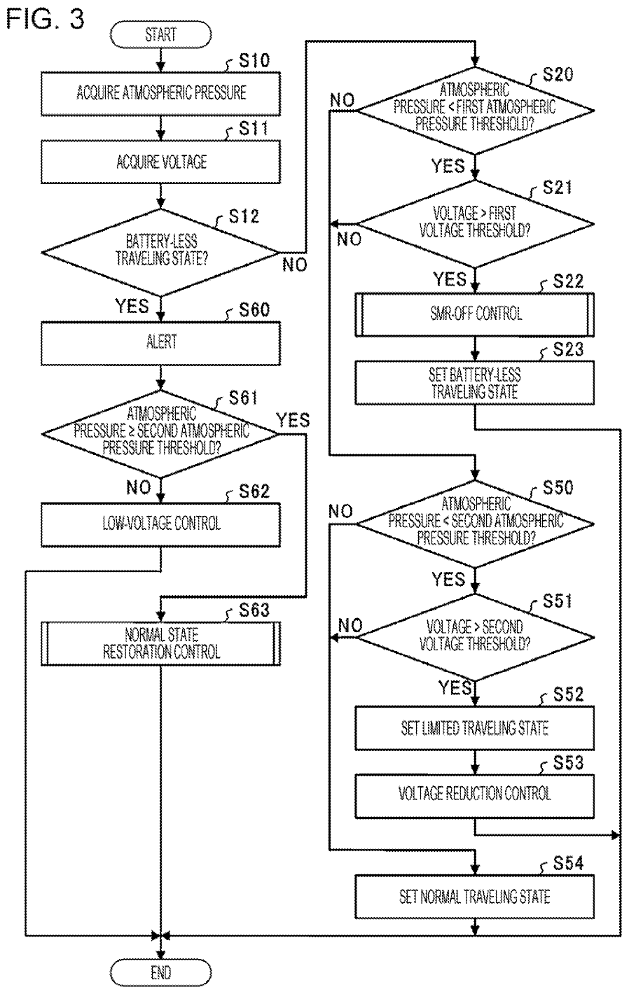

FIG. 3 is a flowchart illustrating a flow of operation of the vehicle controller 80. When the vehicle 1 is in a ready-on state, the vehicle controller 80 turns ON the system main relay 28 and then repeats a series of processes in FIG. 3 until the vehicle 1 is switched to a ready-off state. The vehicle controller 80 repeats the series of processes in FIG. 3 at every predetermined interrupt timing coming after an elapse of a predetermined period.

When the predetermined interrupt timing has come, the vehicle controller 80 acquires a current atmospheric pressure detected by the atmospheric pressure sensor 60 (S10). The vehicle controller 80 acquires a current voltage of the output terminals 40 of the battery pack 24 detected by the voltage sensor 62 (S11).

The vehicle controller 80 determines whether the current state of the vehicle is the battery-less traveling state (S12).

When the current state of the vehicle is not the battery-less traveling state (NO in S12), the vehicle controller 80 determines whether the acquired atmospheric pressure is lower than the first atmospheric pressure threshold Pth1 (S20).

When the acquired atmospheric pressure is lower than the first atmospheric pressure threshold Pth1 (YES in S20), the vehicle controller 80 determines whether the acquired voltage is higher than the first voltage threshold Vth1 (S21).

When the acquired voltage is higher than the first voltage threshold Vth1 (S21), the acquired atmospheric pressure belongs to the third atmospheric pressure range and electric discharge may occur at the output terminals 40 of the battery pack 24. In this case, the vehicle controller 80 performs SMR-OFF control for turning OFF the system main relay 28 (S22). The SMR-OFF control (S22) is described later in detail.

When the system main relay is turned OFF by the SMR-OFF control (S22), the vehicle controller 80 sets the state of the vehicle to the battery-less traveling state (S23), and terminates the series of processes.

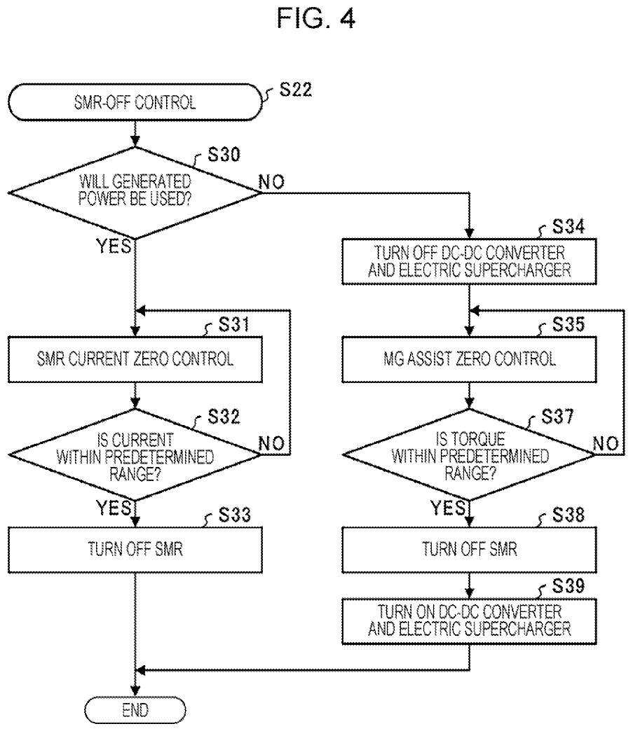

FIG. 4 is a flowchart illustrating a flow of the SMR-OFF control (S22). When the SMR-OFF control is started, the vehicle controller 80 determines whether electric power generated by the motor generator 12 is to be supplied to the low-voltage system wires 52 (S30). This step corresponds to determination as to whether the low-voltage battery 50 is to be regenerated with the electric power generated by the motor generator 12 through the low-voltage system wires 52.

When determination is made that the electric power generated by the motor generator 12 is to be supplied (YES in S30), the vehicle controller 80 performs SMR current zero control for controlling a current flowing through the system main relay 28 to reach zero (S31). If ON/OFF of the system main relay 28 is controlled with a current flowing through the system main relay 28, an electric arc may be generated between the contacts of the system main relay 28 to damage the contacts. The vehicle controller 80 performs the SMR current zero control (S31) as a preparatory process for switching the system main relay 28 to OFF.

While the SMR current zero control (S31) is being performed, the motor generator 12 generates electric power, and the power conversion device 26 converts the electric power generated by the motor generator 12 and supplies the electric power to the high-voltage system wires 22. While the SMR current zero control (S31) is being performed, the DC-DC converter 54 is operating to convert the electric power on the high-voltage system wires 22 and supplies the electric power to the low-voltage system wires 52. In this situation, the current of the system main relay 28 can be controlled by balancing the electric power supplied from the motor generator 12 through the power conversion device 26 and the electric power output from the output end of the DC-DC converter 54.

In the SMR current zero control (S31), the vehicle controller 80 controls the power conversion device 26 and the DC-DC converter 54 while causing the current sensor 64 to monitor the current flowing through the system main relay 28 so that the current of the system main relay 28 reaches substantial zero.

The vehicle controller 80 determines whether the current of the system main relay 28 detected by the current sensor 64 is within a predetermined range including zero (S32). The predetermined range including zero is set to a current range in which the current of the system main relay 28 is regarded as substantial zero in consideration of, for example, measurement variation or control variation. The vehicle controller 80 continues the SMR current zero control (S31) until the current of the system main relay 28 enters the predetermined range (NO in S32).

When the current of the system main relay 28 is within the predetermined range (YES in S32), the vehicle controller 80 switches the system main relay 28 from ON to OFF (S33), and terminates the SMR-OFF control (S22).

When determination is made in Step S30 that the electric power generated by the motor generator 12 is not to be supplied (NO in S30), the vehicle controller 80 temporarily turns OFF the DC-DC converter 54 and the electric supercharger 34 (S34). Thus, the power consumption through the high-voltage system wires 22 is substantial zero.

The vehicle controller 80 performs MG assist zero control for rotating the motor generator 12 with a zero torque (S35). When the motor generator 12 rotates with the zero torque, the motor generator 12 is in a neutral state instead of power running and regeneration. In the zero torque state, the current of the system main relay 28 can reach substantial zero because there is no electric power moving from the high-voltage system wires 22 to the motor generator 12 or moving from the motor generator 12 to the high-voltage system wires 22.

In the MG assist zero control (S35), the vehicle controller 80 controls the power conversion device 26 so that the torque of the motor generator 12 reaches substantial zero.

The vehicle controller 80 determines whether the torque of the motor generator 12 is within a predetermined range including zero (S37). The predetermined range including zero is set to a torque range in which the torque of the motor generator 12 is regarded as substantial zero in consideration of, for example, control variation. The vehicle controller 80 continues the MG assist zero control (S35) until the torque of the motor generator 12 enters the predetermined range (NO in S37).

When the torque of the motor generator 12 is within the predetermined range (YES in S37), the vehicle controller 80 switches the system main relay 28 from ON to OFF (S38).

The vehicle controller 80 turns ON again the DC-DC converter 54 and the electric supercharger 34 that have been turned OFF in Step S34 (S39), and terminates the SMR-OFF control (S22).

Referring back to FIG. 3, when the acquired atmospheric pressure is equal to or higher than the first atmospheric pressure threshold Pth1 in Step S20 (NO in S20) or the acquired voltage is equal to or lower than the first voltage threshold Vth1 (NO in S21), the vehicle controller 80 proceeds to a process of Step S50.

When the acquired atmospheric pressure belongs to the third atmospheric pressure range but the acquired voltage is equal to or lower than the first voltage threshold Vth1, the acquired voltage belongs to the insulation range and electric discharge is less likely to occur. Therefore, the vehicle controller 80 proceeds to the process of Step S50.

In Step S50, the vehicle controller 80 determines whether the acquired atmospheric pressure is lower than the second atmospheric pressure threshold Pth2 (S50).

When the acquired atmospheric pressure is lower than the second atmospheric pressure threshold Pth2 (YES in S50), the vehicle controller 80 determines whether the acquired voltage is higher than the second voltage threshold Vth2 (S51).

When the acquired voltage is higher than the second voltage threshold Vth2 (YES in S51), the acquired atmospheric pressure belongs to the second atmospheric pressure range and electric discharge may occur at the output terminals 40 of the battery pack 24. In this case, the vehicle controller 80 sets the state of the vehicle to the limited traveling state (S52), performs voltage reduction control for reducing the voltage of the output terminals 40 of the battery pack 24 based on the acquired atmospheric pressure (S53), and terminates the series of processes.

When the acquired atmospheric pressure is equal to or higher than the second atmospheric pressure threshold Pth2 in Step S50 (NO in S50) or the acquired voltage is equal to or lower than the second voltage threshold Vth2 (NO in S51), the vehicle controller 80 sets the state of the vehicle to the normal traveling state (S54), and terminates the series of processes. When the acquired atmospheric pressure belongs to the second atmospheric pressure range but the acquired voltage is equal to or lower than the second voltage threshold Vth2, the acquired voltage belongs to the insulation range and electric discharge is less likely to occur. Therefore, the vehicle controller 80 proceeds to the process of Step S54.

When the current state of the vehicle is the battery-less traveling state in Step S12 (YES in S12), the vehicle controller 80 issues a predetermined alert (S60). For example, the predetermined alert may be a predetermined indication of “low atmospheric pressure” or “high altitude” displayed on an instrument panel. The predetermined alert may be a message “Please move to low-altitude place.” to give a prompt to move the vehicle 1 to a place where the atmospheric pressure is high. The predetermined alert is not limited to these examples and may be any alert as long as the occupant of the vehicle 1 can grasp that the state of the vehicle is the battery-less traveling state.

The vehicle controller 80 determines whether the acquired atmospheric pressure is equal to or higher than the second atmospheric pressure threshold Pth2 (S61).

When the acquired atmospheric pressure is lower than the second atmospheric pressure threshold Pth2 (NO in S61), the battery-less traveling state is kept. In this case, the vehicle controller 80 performs low-voltage control for controlling the voltage of the output terminals 40 of the battery pack 24 to reach a voltage equal to the third voltage threshold Vth3 by controlling the power of the engine 10 (S62), and terminates the series of processes.

When the acquired atmospheric pressure is equal to or higher than the second atmospheric pressure threshold Pth2 (YES in S61), the vehicle controller 80 performs normal state restoration control for restoring the state of the vehicle to the normal traveling state (S63), and terminates the series of processes. The normal state restoration control (S63) is described later in detail.

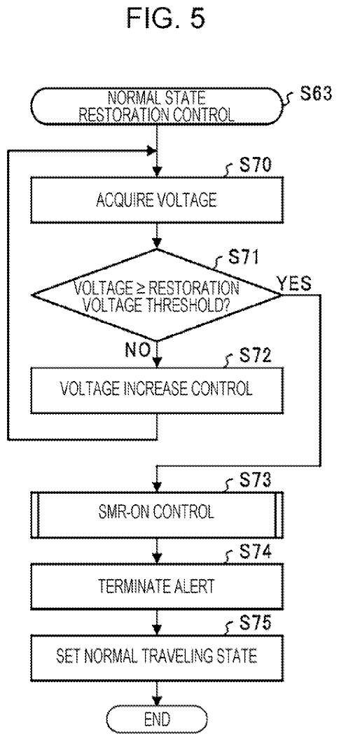

FIG. 5 is a flowchart illustrating a flow of the normal state restoration control (S63). When the normal state restoration control (S63) is started, the vehicle controller 80 acquires a current voltage of the output terminals 40 of the battery pack 24 detected by the voltage sensor 62 (S70).

The vehicle controller 80 determines whether the acquired voltage is equal to or higher than a restoration voltage threshold (S71). For example, the restoration voltage threshold is set to a voltage higher than the voltage of the third voltage threshold Vth3 by a predetermined amount of voltage. The predetermined amount of voltage may be set to any amount within a range in which the restoration voltage threshold does not exceed the second voltage threshold Vth2 in consideration of, for example, a normal voltage of the high-voltage battery 20 in the normal traveling state.

When the acquired voltage is lower than the restoration voltage threshold (NO in S71), the vehicle controller 80 performs voltage increase control for increasing the voltage of the output terminals 40 of the battery pack 24 (S72). The vehicle controller 80 acquires the voltage again (S70), and determines whether the acquired voltage is equal to or higher than the restoration voltage threshold (S71).

In the voltage increase control (S72), the vehicle controller 80 increases the electric power generated by the motor generator 12 by, for example, performing control to increase the power of the engine 10. When the generated electric power increases, the amount of electric power supplied to the high-voltage system wires increases. As a result, the voltage of the output terminals 40 of the battery pack 24 increases. The voltage increase control (S72) corresponds to termination of the voltage limitation in the battery-less traveling state.

When the acquired voltage is equal to or higher than the restoration voltage threshold (YES in S71), the vehicle controller 80 performs SMR-ON control for turning ON the system main relay 28 (S73). The SMR-ON control (S73) is described later in detail.

After the SMR-ON control (S73), the vehicle controller 80 terminates the alert issued in the battery-less traveling state (S74). The vehicle controller 80 sets the state of the vehicle to the normal traveling state (S75), and terminates the normal state restoration control (S63).

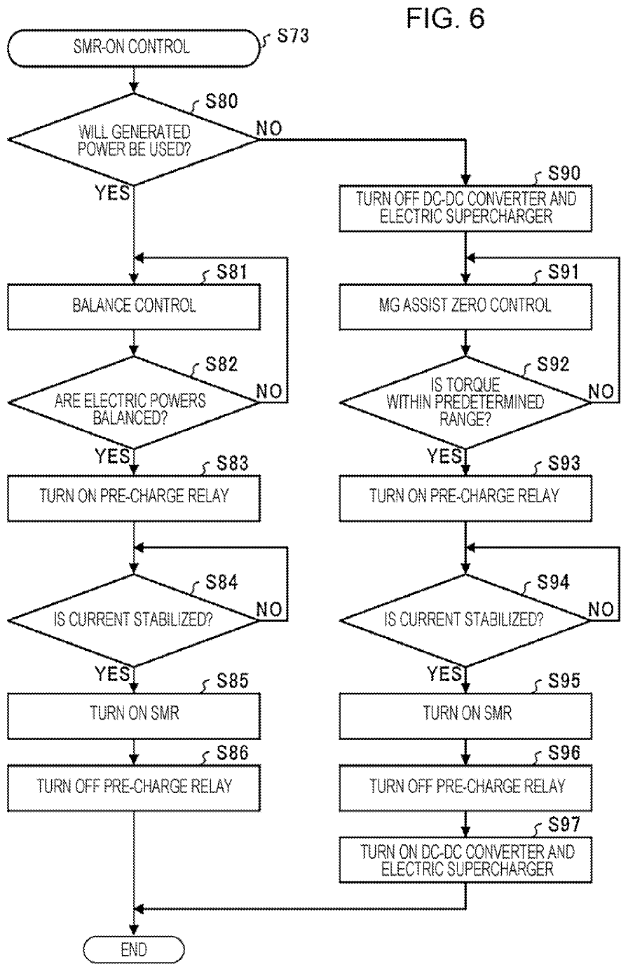

FIG. 6 is a flowchart illustrating a flow of the SMR-ON control (S73). When the SMR-ON control (S73) is started, the vehicle controller 80 determines whether electric power generated by the motor generator 12 is to be supplied to the low-voltage system wires 52 (S80). This step corresponds to determination as to whether the low-voltage battery 50 is to be regenerated with the electric power generated by the motor generator 12 through the low-voltage system wires 52.

When determination is made that the electric power generated by the motor generator 12 is to be supplied (YES in S80), the vehicle controller 80 performs balance control for controlling the electric power generated by the motor generator 12 and the output of the DC-DC converter 54 to become equal to each other (S81).

When the balance control is performed, the system main relay 28 is OFF but a current caused by the power generation by the motor generator 12 flows through the high-voltage system wires 22 closer to the motor generator 12 than is the system main relay 28. If a large current flows when the system main relay 28 is switched from OFF to ON, an electric arc may be generated between the contacts of the system main relay 28 to damage the contacts. The vehicle controller 80 performs the balance control (S81) as a preparatory process for switching the system main relay 28 to ON.

In the balance control, the vehicle controller 80 derives electric power at the output end of the DC-DC converter 54 based on, for example, a switching operation of the DC-DC converter 54. The vehicle controller 80 controls the power of the engine 10 so that the electric power generated by the motor generator 12 becomes substantially the same as the electric power at the output end of the DC-DC converter 54. When the electric power generated by the motor generator 12 becomes substantially the same as the electric power at the output end of the DC-DC converter 54, most of the electric power generated by the motor generator 12 is sent to the low-voltage system wires. Thus, it is possible to reduce the current flowing through the system main relay 28 when the system main relay 28 is switched to ON.

The vehicle controller 80 continues the balance control (S81) until the electric power generated by the motor generator 12 and the electric power at the output end of the DC-DC converter 54 are balanced (NO in S82).

When the electric powers are balanced (YES in S82), the vehicle controller 80 turns ON the pre-charge relay 30 (S83). The vehicle controller 80 waits until the current of the output terminals 40 of the battery pack 24 is stabilized (S84).

When the current of the output terminals 40 of the battery pack 24 is stabilized (YES in S84), the vehicle controller 80 turns ON the system main relay 28 (S85). The vehicle controller 80 turns OFF the pre-charge relay 30 (S86), and terminates the SMR-ON control (S73).

By turning ON the system main relay 28 after the pre-charge relay 30 is turned ON, an inrush current can be reduced when the system main relay 28 is turned ON.

When determination is made in Step S80 that the electric power generated by the motor generator is not to be supplied (NO in S80), the vehicle controller 80 temporarily turns OFF the DC-DC converter 54 and the electric supercharger 34 (S90). Thus, the power consumption through the high-voltage system wires 22 is substantial zero.

The vehicle controller 80 performs MG assist zero control for rotating the motor generator 12 with a zero torque (S91). The MG assist zero control (S91) is the same as the MG assist zero control (S35) in the SMR-OFF control (S22). In the zero torque state, the current of the system main relay 28 can reach substantial zero because there is no electric power moving from the high-voltage system wires 22 to the motor generator 12 or moving from the motor generator 12 to the high-voltage system wires 22.

The vehicle controller determines whether the torque of the motor generator is within a predetermined range including zero (S92). The vehicle controller 80 continues the MG assist zero control (S91) until the torque of the motor generator 12 enters the predetermined range (NO in S92).

When the torque of the motor generator 12 is within the predetermined range (YES in S92), the vehicle controller 80 turns ON the pre-charge relay 30 (S93). The vehicle controller 80 waits until the current of the output terminals 40 of the battery pack 24 is stabilized (S94).

When the current of the output terminals 40 of the battery pack 24 is stabilized (YES in S94), the vehicle controller 80 turns ON the system main relay 28 (S95). The vehicle controller 80 turns OFF the pre-charge relay 30 (S96). The vehicle controller 80 turns ON again the DC-DC converter 54 and the electric supercharger 34 that have been turned OFF in Step S90 (S97), and terminates the SMR-ON control (S73).

As described above, the vehicle 1 of this embodiment includes the atmospheric pressure sensor 60 that detects the atmospheric pressure at the position of the vehicle. When the system main relay 28 is ON and the atmospheric pressure detected by the atmospheric pressure sensor 60 is lower than the first atmospheric pressure threshold Pth1, the vehicle controller 80 of the vehicle 1 of this embodiment performs the SMR-OFF control for turning OFF the system main relay 28 (S22).

In the vehicle 1 of this embodiment, when the atmospheric pressure decreases, the system main relay 28 is turned OFF and the high-voltage battery 20 is electrically isolated from the high-voltage system wires 22. Therefore, the vehicle 1 of this embodiment can suppress the electric discharge at, for example, the output terminals 40 of the battery pack 24 even though the atmospheric pressure is low.

In the vehicle 1 of this embodiment, determination is made in the SMR-OFF control as to whether the electric power generated by the motor generator 12 is to be supplied to the low-voltage system wires. In the vehicle 1 of this embodiment, when determination is made that the electric power generated by the motor generator 12 is to be supplied, the SMR current zero control is performed to control the current flowing through the system main relay 28 to reach zero, and the system main relay 28 is turned OFF. In the vehicle 1 of this embodiment, when determination is made that the electric power generated by the motor generator 12 is not to be supplied, the MG assist zero control is performed to rotate the motor generator 12 with a zero torque, and the system main relay 28 is turned OFF. Therefore, in the vehicle 1 of this embodiment, the electric arc between the contacts of the system main relay 28 can be suppressed when turning OFF the system main relay 28. Thus, damage to the system main relay 28 can be suppressed.

In the vehicle 1 of this embodiment, the state of the vehicle is set to the battery-less traveling state when the system main relay 28 is OFF through the SMR-OFF control. Therefore, in the vehicle 1 of this embodiment, the vehicle 1 can travel even though the system main relay 28 is turned OFF. Thus, a decrease in convenience can be suppressed.

In the vehicle 1 of this embodiment, when the state of the vehicle is the battery-less traveling state and the atmospheric pressure detected by the atmospheric pressure sensor 60 is equal to or higher than the second atmospheric pressure threshold Pth2 that is higher than the first atmospheric pressure threshold Pth1, the normal state restoration control is performed to restore the state of the vehicle to the normal traveling state. Therefore, in the vehicle 1 of this embodiment, the state of the vehicle can appropriately return to the normal traveling state when the vehicle returns from a place of a low atmospheric pressure to a place of a standard atmospheric pressure. In the vehicle 1 of this embodiment, the second atmospheric pressure threshold Pth2 serving as a determination reference for the normal state restoration control is higher than the first atmospheric pressure threshold Pth1 serving as a determination reference for transition to the battery-less traveling state. Therefore, it is possible to suppress chattering in which the control is frequently switched between the control for transition to the battery-less traveling state due to a decrease in the atmospheric pressure and the control for termination of the battery-less traveling state due to an increase in the atmospheric pressure.

In the vehicle 1 of this embodiment, determination is made in the normal state restoration control as to whether the electric power generated by the motor generator 12 is to be supplied to the low-voltage system wires 52. In the vehicle 1 of this embodiment, when determination is made that the electric power generated by the motor generator 12 is to be supplied, the balance control is performed to control the electric power generated by the motor generator 12 and the output of the DC-DC converter 54 to become equal to each other, and the system main relay 28 is turned ON. In the vehicle 1 of this embodiment, when determination is made that the electric power generated by the motor generator 12 is not to be supplied, the MG assist zero control is performed to rotate the motor generator 12 with a zero torque, and the system main relay 28 is turned ON. Therefore, in the vehicle 1 of this embodiment, the electric arc between the contacts of the system main relay 28 can be suppressed when turning ON the system main relay 28. Thus, damage to the system main relay 28 can be suppressed.

In the vehicle 1 of this embodiment, the voltage of the output terminals 40 of the battery pack 24 is reduced based on the atmospheric pressure when the system main relay 28 is ON and the atmospheric pressure detected by the atmospheric pressure sensor 60 is in a range lower than the second atmospheric pressure threshold Pth2 and equal to or higher than the first atmospheric pressure threshold Pth1. Therefore, in the vehicle 1 of this embodiment, it is possible to keep the traveling of the vehicle 1 by the motor generator 12 and to suppress the electric discharge due to a decrease in the atmospheric pressure.

Although the embodiment of the disclosure has been described above with reference to the accompanying drawings, the embodiment of the disclosure is not limited to this embodiment. It is understood that various modifications and revisions are conceivable by persons having ordinary skill in the art within the scope of claims and are included in the technical scope disclosed herein.

The control device 70 illustrated in FIG. 1 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control device 70 including the vehicle controller 80. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 1.

1. A vehicle comprising:
a high-voltage battery;
a motor generator;
a high-voltage system wire configured to electrically couple the high-voltage battery and the motor generator;
a system main relay configured to turn ON or OFF electric coupling between the high-voltage battery and the motor generator on the high-voltage system wire;
an atmospheric pressure sensor configured to detect an atmospheric pressure at a position of the vehicle; and
a control device,
wherein the control device comprises:
one or more processors; and
one or more memories coupled to the one or more processors, and
wherein the one or more processors are configured to execute a process comprising performing SMR-OFF control for controlling the system main relay to turn OFF when the system main relay is ON and the atmospheric pressure detected by the atmospheric pressure sensor is lower than a first atmospheric pressure threshold.

2. The vehicle according to claim 1, further comprising a DC-DC converter comprising an input end electrically coupled between the system main relay and the motor generator on the high-voltage system wire and an output end coupled to a low-voltage system wire, the DC-DC converter being configured to convert electric power on the high-voltage system wire and supply the converted electric power to the low-voltage system wire,
wherein the process further comprises:
in the SMR-OFF control,
determining whether electric power generated by the motor generator is to be supplied to the low-voltage system wire;
when it is determined that the electric power generated by the motor generator is to be supplied, performing SMR current zero control for controlling a current flowing through the system main relay to reach zero, and turning OFF the system main relay; and
when it is determined that the electric power generated by the motor generator is not to be supplied, performing MG assist zero control for controlling the motor generator to rotate with a zero torque, and turning OFF the system main relay.

3. The vehicle according to claim 1, further comprising an engine,
wherein the process further comprises, when the system main relay is OFF through the SMR-OFF control, setting a state of the vehicle to a battery-less traveling state in which the vehicle is travelable by using the engine and electric power is generable by the motor generator.

4. The vehicle according to claim 3, wherein the process further comprises, when the state of the vehicle is the battery-less traveling state and the atmospheric pressure detected by the atmospheric pressure sensor is equal to or higher than a second atmospheric pressure threshold that is higher than the first atmospheric pressure threshold, performing normal state restoration control for causing the state of the vehicle to restore to a normal traveling state in which the vehicle is travelable by using the motor generator.

5. The vehicle according to claim 4, further comprising a DC-DC converter comprising an input end electrically coupled between the system main relay and the motor generator on the high-voltage system wire and an output end coupled to a low-voltage system wire, and configured to convert electric power on the high-voltage system wire and supply the electric power to the low-voltage system wire,
wherein the process further comprising:
in the normal state restoration control,
determining whether electric power generated by the motor generator is to be supplied to the low-voltage system wire;
when it is determined that the electric power generated by the motor generator is to be supplied, performing balance control for controlling the electric power generated by the motor generator and an output of the DC-DC converter to become equal to each other, and turning ON the system main relay; and
when it is determined that the electric power generated by the motor generator is not to be supplied, performing MG assist zero control for controlling the motor generator to rotate with a zero torque, and turning ON the system main relay.
